(19) United States
(12) Patent Application Publication
(10) Pub. No.: US 2017/0267556 A1
(43) Pub. Date: Sep. 21, 2017

(54) MANAGING NATURALLY OCCURRING RADIOACTIVE MATERIAL IN WASTEWATER

(71) Applicant: University of Pittsburgh - Of the Commonwealth System of Higher Education, Pittsburgh, PA (US)

(72) Inventor: Radisav D. Vidic, Pittsburgh, PA (US)

(21) Appl. No.: 15/460,302

(22) Filed: Mar. 16, 2017

Related U.S. Application Data
(60) Provisional application No. 62/310,291, filed on Mar. 18, 2016.

(51) Int. Cl. C02F 1/52

(52) U.S. Cl. CPC C02F 1/5236; C02F 1/5209; C02F 1/5281; C02F 2101/10

(57) ABSTRACT

A method of treating wastewater including calcium ions and radium ions includes charging the wastewater into a container via an inlet in the container, precipitating a portion of the calcium ions in the wastewater within the container as calcium carbonate, removing an outflow via an outlet in the container, and recycling a portion of calcium carbonate precipitates formed in the container and removed in the outflow back into the container to achieve requisite removal of NORM present in the flowback water and produce limited volume of sludge that can be easily disposed in Class II disposal wells.

### CROSS-REFERENCE TO RELATED APPLICATIONS

This application claims benefit of U.S. Provisional Patent Application Ser. No. 62/310,291, filed Mar. 18, 2016, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Treatment, handling, storage and/or disposal of wastewater or flowback water from subterranean hydrocarbon recovery (for example, recovery of natural gas and oil from shale deposits such as Marcellus shale) is increasingly problematic. Much of such wastewater includes naturally occurring radioactive materials (NORM). Class II injection wells under the Underground Injection Control program of the United States Environmental Protection Agency (EPA) are used exclusively to inject fluids associated with oil and natural gas production. Class II wells fall into one of three categories: disposal wells, enhanced recovery wells and hydrocarbon storage wells. Class II disposal wells make up about only 20% of the total number of Class II wells. In many areas, Class II disposal wells are very limited. For example, in Pennsylvania there are only seven such wells in the state, and the disposal capacity of those wells is quite limited.

### SUMMARY

In one aspect, a method of treating wastewater including calcium and radium ions (for example, from underground hydraulic fracturing operations) includes charging the wastewater into a container via an inlet in the container, precipitating a portion of the calcium in the wastewater within the container as calcium carbonate, removing an outflow via an outlet in the container, and recycling at least a portion of calcium carbonate precipitates (which are formed in the container and removed in the outflow) back into the container. In a number of embodiments, the method includes charging a source of carbonate ions into the container to create a mixture of the wastewater and the source of carbonate ions in an aqueous medium within the container and precipitating between approximately 10 to 60% of the calcium by weight in the wastewater in the form of calcium carbonate. In a number of embodiments, 20% to 60% by weight of the calcium in the wastewater is precipitated as calcium carbonate. The portion of the calcium carbonate recycled to the container may, for example, be recycled from a settling system, which may, for example, be in fluid connection with the outlet of the container.

In a number of embodiments, a sludge recirculation ratio is in the range of 25 to 100 wherein the sludge recirculation ratio is defined as the mass of recirculated calcium carbonate divided by the mass of calcium carbonate created in the container. In a number of embodiments, 25 to 40% by weight of the calcium in the wastewaters is precipitated as calcium carbonate, and the sludge recirculation ratio is in the range of 30 to 80.

The calcium carbonate produced in the method includes at least 90%, at least 95% or at least 98% of radium from the wastewater. The source of carbonate ions may, for example, be sodium carbonate or potassium carbonate. In a number of embodiments, the source of carbonate ions is sodium carbonate.

The method may further include depositing the calcium carbonate with radium into a subterranean storage volume. The calcium carbonate with radium may, for example, be solubilized before depositing the calcium carbonate with radium in the subterranean storage volume (for example, by pumping a liquid in which the calcium carbonate with radium is solubilized into a class II well).

In another aspect, a system for treating wastewater including calcium and radium ions (for example, from underground hydraulic fracturing operations) includes a container, a source of the wastewater in fluid connection with the container, a source of carbonate ions in fluid connection with the container, a settling system in fluid connection with an outlet of the container, a recycle conduit in fluid connection between the settling system and the container to recycle solid calcium carbonate precipitated within the container and settled in the settling system to the container, and a control system operable to control the flow of the source of carbonate ions to the container to cause precipitation of only a portion of calcium in the wastewater and to control the amount of calcium carbonate recycled to the container via the recycle conduit.

The control system may, for example, be configured to control flow from the source of carbonate ions into the container to create a mixture of the wastewater and the source of carbonate ions in an aqueous medium within the container to precipitate between approximately 10 to 60% of the calcium by weight in the wastewater in the form of calcium carbonate. In a number of embodiments, 20% to 60% by weight of the calcium in the wastewater is precipitated as calcium carbonate.

In a number of embodiments, the control system is configured to control a sludge recirculation ratio to be in the range of 25 to 100, wherein the sludge recirculation ratio is defined as the mass of recirculated calcium carbonate divided by the mass of calcium carbonate created in the container. The control system may, for example, be configured to cause 25 to 40% of the calcium in the wastewater to be precipitated as calcium carbonate and to cause the sludge recirculation ratio to be in the range of 30 to 80.

As described above, calcium carbonate produced in the system may include at least 90%, at least 95% or at least 98% of radium from the wastewater.

In a further aspect, a method of treating wastewater including calcium ions and radium ions from underground hydraulic fracturing operations includes charging the wastewater into a container via an inlet in the container, precipitating a portion of the calcium ions in the wastewater within the container and co-precipitating a portion of the radium ions, removing an outflow via an outlet in the container, and recycling at least a portion of precipitant formed in the container and removed in the outflow back into the container to adsorb additional radium ions. The calcium ions may, for example, be precipitated as calcium carbonate.

The present devices, systems, and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates a study of the removal percentage (via precipitation) of various flowback water components as a function of time upon addition of sodium carbonate when total carbonate added is 10% of total divalent cations in solution.

FIG. 2 illustrates a comparison of actual Ra removal via co-precipitation with CaCO₃ with theoretical prediction using a distribution coefficient.

FIG. 3A illustrates a study of the effect of ionic strength on Ra removal with CaCO₃ at an initial Ca concentration (Ca₀) of 3,000 mg/L in synthetic flowback water.

FIG. 3B illustrates a study of the effect of ionic strength on Ra removal with CaCO₃ at an initial Ca concentration (Ca₀) of 9,000 mg/L in synthetic flowback water.

FIG. 4 illustrates a study of the effect of ionic strength and solids concentration on the removal of Ra with CaCO₃ in a post-precipitation process in synthetic flowback water.

FIG. 5 illustrates a study of the release of Ra from precipitated CaCO₃.

FIG. 6A illustrates a comparison of actual Ra removal via co-precipitation with CaCO₃ with theoretical prediction using a distribution coefficient in synthetic flowback water and real flowback water.

FIG. 6B illustrates a comparison of actual Ra removal via post-precipitation processing with CaCO₃ in synthetic flowback water and real flowback water.

FIG. 7 illustrates a study of the kinetics of Ra removal in real produced water during post-precipitation processing.

FIG. 8 illustrates schematically an embodiment of a system hereof including sludge recirculation of precipitated CaCO₃ from a settling tank to a reaction tank in which soda ash (Na₂CO₃) is added to flowback water.

FIG. 9 illustrates a schematic representation of a simulated sludge recirculation process where Ra removal in Beaker B occurred by both co-precipitation and post-precipitation because of the calcite solids added from Beaker A.

FIG. 10 illustrates Ra removal at various sludge recirculation ratios for a number of different percentages of removal of Ca from flowback water via CaCO₃ precipitation.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a source of carbonate ions” includes a plurality of such sources of carbonate ions and equivalents thereof known to those skilled in the art, and so forth, and reference to “the source of carbonate ions” is a reference to one or more such sources of carbonate ions and equivalents thereof known to those skilled in the art, and so forth. Recitation of ranges of values herein are merely intended to serve as a shorthand method of referring individually to each separate value falling within the range. Unless otherwise indicated herein, and each separate value, as well as intermediate ranges, are incorporated into the specification as if individually recited herein. All methods described herein can be performed in any suitable order unless otherwise indicated herein or otherwise clearly contraindicated by the text.

“Controller” or “control system” as used herein includes, but is not limited to, any circuit or device that coordinates and controls the operation of one or more input or output devices. For example, a controller can include a device having one or more processors, microprocessors, or central processing units (CPUs) capable of being programmed to or configured to perform input or output functions.

The terms “electronic circuitry”, “circuitry” or “circuit,” as used herein includes, but is not limited to, hardware, firmware, software or combinations of each to perform a function(s) or an action(s). For example, based on a desired feature or need. a circuit may include a software controlled microprocessor, discrete logic such as an application specific integrated circuit (ASIC), or other programmed logic device. A circuit may also be fully embodied as software. As used herein, “circuit” is considered synonymous with “logic.” The term “logic”, as used herein includes, but is not limited to, hardware, firmware, software or combinations of each to perform a function(s) or an action(s), or to cause a function or action from another component. For example, based on a desired application or need, logic may include a software controlled microprocessor, discrete logic such as an application specific integrated circuit (ASIC), or other programmed logic device. Logic may also be fully embodied as software.

The term “processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random access memory (RAM), read-only memory (ROM), programmable read-only memory (PROM), erasable programmable read only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

The term “software,” as used herein includes, but is not limited to, one or more computer readable or executable instructions that cause a computer or other electronic device to perform functions, actions, or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

Recently, it has been shown that recovery of barite from shale gas-produced water further removed NORM and produced water suitable for reuse in drilling operations. In that process, NORM present in flowback water is sequestered with barite, which can be recovered and used as a weighting agent in drilling mud. However, in case there is no market for recovered barite, a complementary technology as described herein allows sequestration of NORM in a small volume of solid waste that can be easily liquefied (that is, dissolved) and disposed locally in a Class II injection well or shipped for disposal in a remote Class II well. Barite-bearing waste cannot be liquefied because barite is not soluble in any solvent that may have industrial relevance, and solids cannot be injected into a Class II well.

Table 1 below sets forth typical composition of Marcellus shale flowback water or wastewater. Typically, 7000-18,000 m³ of water are used for hydraulic fracturing of each well. The large water volume, the high concentration of dissolved solids, and the complex physicochemical composition of the flowback water lead to growing public concern about management of this water because of the potential for environmental and human health impacts. The two radium isotopes typically found in flowback water or waste water are ²²⁶Ra (half-life of 1,600 years) and ²²⁸Ra (half-life of 5.8 years). The U.S. Environmental Protection Agency (EPA) limit for radium or Ra (combined ²²⁶Ra/²²⁸Ra) in drinking water in the U.S. is 5 pCi/L

TABLE 1

| | Low | Medium | High |
|---|---|---|---|
| Constituent | (mg/L) | (mg/L) | (mg/L) |
| Total dissolved solids | 66,000 | 150,000 | 261,000 |
| Total suspended solids | 27 | 380 | 3200 |
| Hardness (as CaCO₃) | 9100 | 29,000 | 55,000 |
| Alkalinity (as CaCO₃) | 200 | 200 | 1,100 |
| Chloride | 32,000 | 76,000 | 148,000 |
| Sulfate | ND | 7 | 500 |
| Sodium | 18,000 | 33,000 | 44,000 |
| Calcium | 3,000 | 9,800 | 31,000 |
| Strontium | 1,400 | 2,100 | 6,800 |
| Barium | 2,300 | 3,300 | 4,700 |
| Bromide | 720 | 1,200 | 1,600 |
| Iron | 25 | 48 | 55 |
| Magnesium | 3 | 7 | 7 |
| Oil and grease | 10 | 18 | 269 |
| Radium (Ra; pCi/L) | — | 5,350 | — |

In a number of embodiments hereof, Ra is removed from, for example, subterranean hydrocarbon recovery wastewater via a process of precipitation of Calcium (Ca) from the wastewater (as, for example, calcium carbonate) with Ra removal during co-precipitation and/or post-precipitation. In a number of representative embodiments, calcium is precipitated from the wastewater by addition of a carbonate compound such as sodium carbonate (Na₂CO₃) or soda ash in a softening process to remove divalent cations, including Ra, from flowback water. In general, any source of carbonate may be used including soda ash, potash (potassium carbonate), etc. The choice of carbonate may, for example, be based upon cost.

A number of advantages are provided in such an approach. For example, it has been discovered that Ra can be effectively removed by precipitating only a moderate amount of solids from the flowback water as carbonates, thereby removing only part of the salinity in flowback water. Moreover, unlike sulfate precipitation in which barite is produced, the resultant radioactive carbonate solids can be dissolved in acid and disposed by deep-well injection in, for example, a Class II well.

Studies of Ra removal via carbonate precipitation (through co-precipitation and post-precipitation adsorption) were first made using a synthetic simulant for flowback water. In a number of studies, the order of reaction during carbonate precipitation when a limited amount of Na₂CO₃ is used for treatment using synthetic flowback water was studied using PHREEQC software with a Pitzer model. PHREEQC is a computer program designed to perform a wide variety of aqueous geochemical calculations. PHREEQC implements several types of aqueous models, including a Pitzer specific-ion-interaction aqueous model. See, for example, Pankhurst, DA, and Apello, CM, Description of Input and Examples for PHREEQC Version 3—A Computer Program for Speciation, Batch-Reaction, One-Dimensional Transport, and Inverse Geochemical Calculations. Chapter 43 of Section A, Groundwater Book 6, Modeling Techniques, US Department of the Interior, US Geological Survey (2013).

The synthetic water included the concentration of calcium (Ca), barium (Ba), magnesium (Mg) and strontium (Sr) cations as set forth in Table 2 below.

TABLE 2

| | Concentration |
|---|---|
| Composition | (mg/l) |
| Ca²⁺ | 15,021 |
| Ba²⁺ | 236 |
| Mg²⁺ | 1,720 |
| Sr²⁺ | 1,799 |

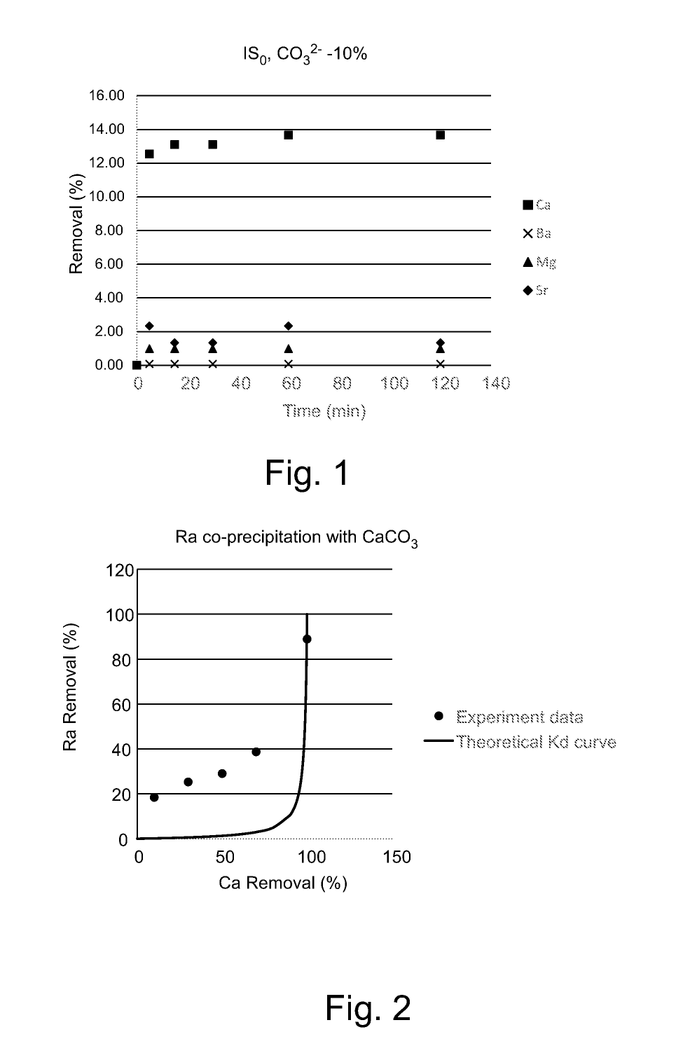

As illustrated in FIG. 1, in the case of removal of divalent cations with a limited carbonate (CO₃²⁻) supply, calcium carbonate or CaCO₃ precipitates first. Higher Ca²⁺ concentration result in a faster rate of CaCO₃ formation. Experiments of the effect of ionic strength on Ca²⁺ removal showed that ionic strength has little impact on Ca²⁺ removal but reduces Ba²⁺ removal. The ionic strength of a solution is a measure of the concentration of ions in that solution. Ionic compounds, when dissolved in water, dissociate into ions.

Solid solution theory is based on the laws of chemical thermodynamics. Ra removal through co-precipitation is a result of lattice replacement as follows:

Ra²⁺+MCO₃=M²⁺+RaCO₃

A distribution coefficient K_{d} describes the affinity of Ra towards different solids as follows:

$${K}_{d} = \frac{( {Ra}^{2 +} / {M}^{2 +} ) solid phase}{( {Ra}^{2 +} / {M}^{2 +} ) liquid phase}$$

Solid solution theory was found to be unable to account for reaction kinetics and external removal mechanisms (for example, adsorption). In that regard, solid solution theory was not accurate in predicting Ra removal in flowback water under realistic process conditions. As illustrated in FIG. 2 (for a theoretical Kd of 0.0013 and a synthetic solution having an initial concentration of Ca²⁺ of 6,000 mg/L and an initial concentration of Ra²⁺ of 5,000 pCi/L) Ra removal was found to be higher than the theoretically predicted value.

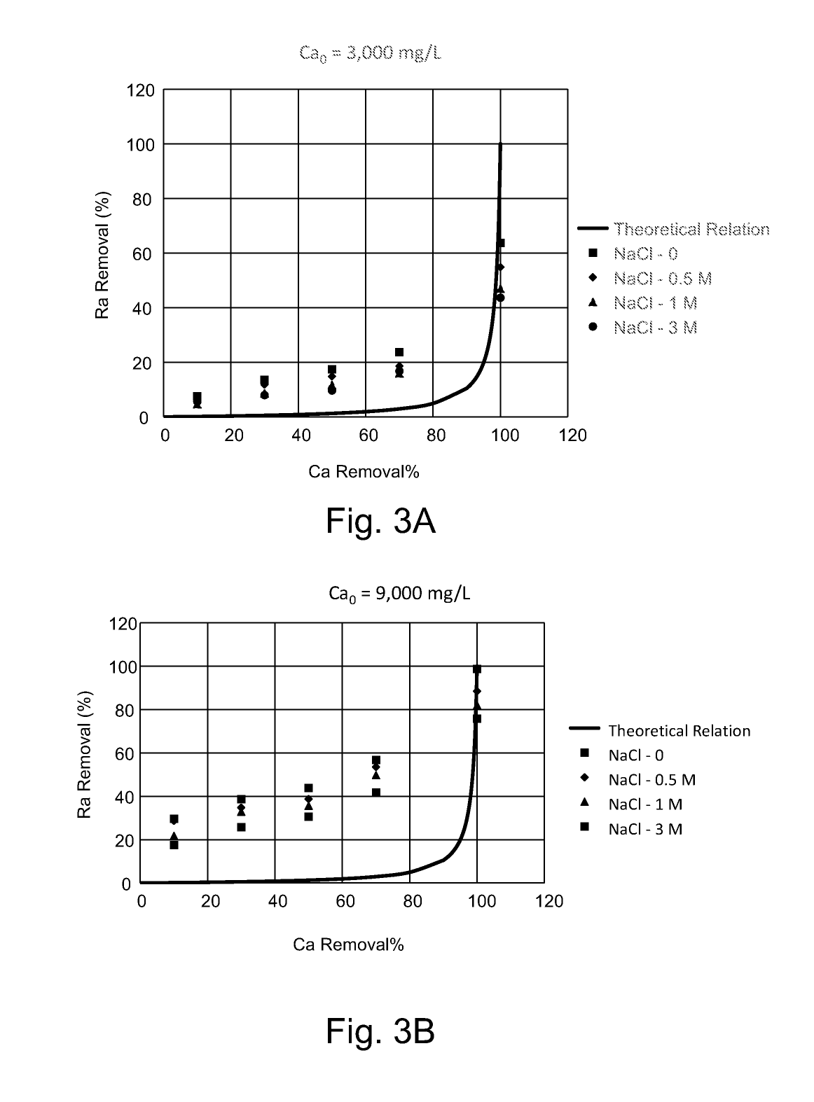

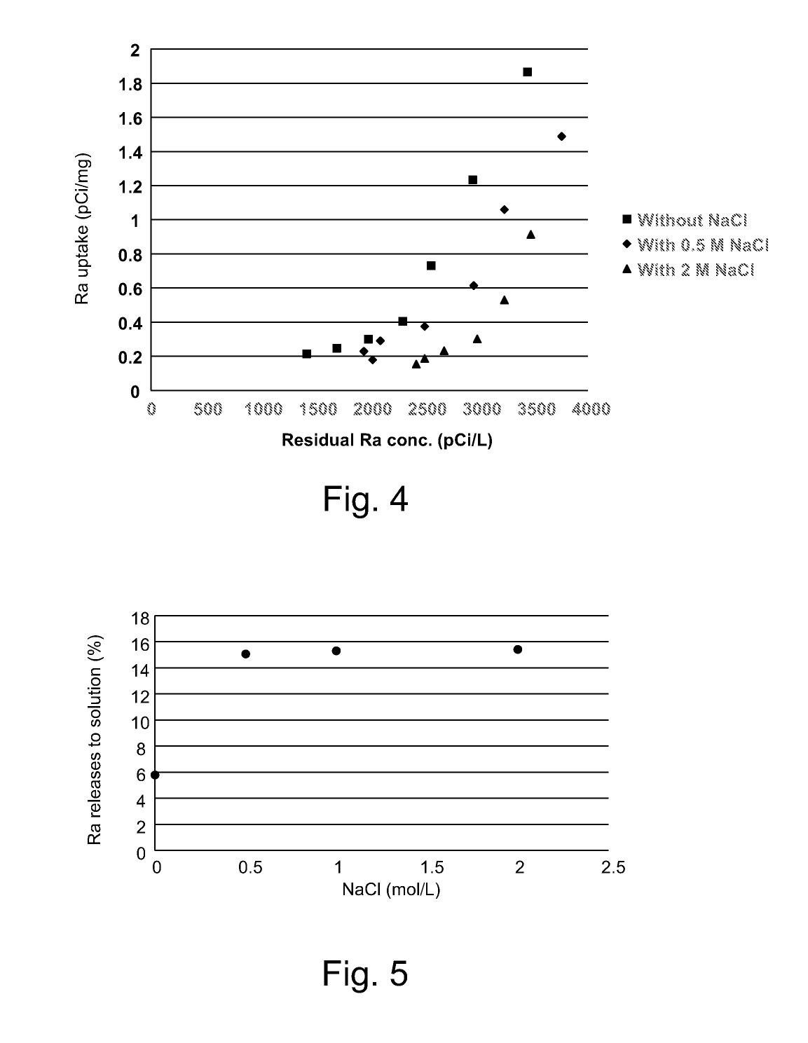

While ionic strength has negative impact on Ra removal, solid concentration has a positive impact on Ra removal. Ionic strength increases the solubility of the carrier resulting in less solids being generated. As illustrated in FIGS. 3A and 3B, for initial Ca concentrations of 3,000 mg/L and 9,000 mg/L, respectively, and at different ionic strengths as determined by NaCl concentration, precipitation of solids enhances Ra removal through co-precipitation and adsorption processes (higher concentration of adsorbent can remove more adsorbate). Also, during post-precipitation Ra removal (for example, via adsorption on already precipitated CaCO₃), increase in ionic strength reduces Ra removal while an increase in solids concentration enhances Ra removal as illustrated in FIG. 4.

Co-precipitation and post-precipitation experiments were conducted under identical conditions in 50 mL HDPE bottles using the liquid volume of 30 ml where CaCO₃ was prepared using CaCl₂ and Na₂CO₃ with Ca²⁺:CO₃²⁻ molar ratio of 1.0. In co-precipitation experiments, Ca²⁺ and Ra²⁺ were first added to the solution followed by the addition of CO₃²⁻ and the solution was allowed to equilibrate for 12 hours. In post-precipitation experiments, Ca²⁺ and CO₃²⁻ were first added to the solution to precipitate CaCO₃ using the reaction time of 3 hours followed by the addition of Ra²⁺ and additional 12 hours of equilibration time. The initial Ra²⁺ concentration was 5,000 pCi/L in both experiments. Experimental results are compared in Table 3.

TABLE 3

| Co-precipitation Experiment | | Post-precipitation Experiment | |
|---|---|---|---|
| Precipitated Ca²⁺ | Ra Removal | Preformed CaCO₃ | Ra Removal |
| (mg/L) | (%) | (mg/L) | (%) |
| 13,333 | 93.5 | 13,333 | 69.6 |
| 6,667 | 78.5 | 6,667 | 57 |

The Ca removal was 100% in the experiments shown in Table 3, and calcite (CaCO₃) concentrations in the co-precipitation and post-precipitation experiments were identical. The results in Table 3 indicate that Ra²⁺ removal is affected by the amount of CaCO₃ solids in the solution when 100% of Ca²⁺ is removed by precipitation as calcite. According to solid-solution theory, Ra²⁺ removal corresponds to Ca²⁺ removal to maintain a constant distribution coefficient. However, these results show that Ra removal depends on the total amount of CaCO₃ solids in solution, which indicates that the use of distribution coefficient does not provide accurate estimate of Ra²⁺ removal.

The difference in Ra²⁺ removal in co-precipitation experiments when 100% of Ca²⁺ is removed as calcite and in post-precipitation experiments with identical calcite concentration in the solution (Table 3) indicates that about 25% of Ra²⁺ is removed by co-precipitation and the rest is removed by post-precipitation (e.g., adsorption) mechanisms. This estimate for Ra removal (that is, 25%) yields a corresponding Ca²⁺ removal of approximately 96% using the theoretical distribution coefficient. This finding supports the hypothesis that the theoretical distribution coefficient can predict Ra removal when only co-precipitation removal mechanism is considered. However, in practical situations, Ra²⁺ removal would be strongly affected by the amount of CaCO₃ solids present in the solution and the post-precipitation mechanism for Ra²⁺ removal needs to be taken into account.

Ra²⁺ release experiments were conducted to determine if the uptake of Ra²⁺ by preformed CaCO₃ is a result of simple and reversible adsorption or if other mechanisms are responsible for Ra²⁺ uptake. These experiments were conducted in 50 mL HDPE bottles using the solution volume of 30 ml. CaCO₃ was first prepared by mixing CaCl₂ and Na₂CO₃ for 3 hours using the initial Ca²⁺ concentration of 15,000 mg/L and Ca²⁺:CO₃²⁻ molar ratio of 1.0. CaCO₃ solids were separated by filtration and transferred to a new bottle containing DI water to which Ra²⁺ was added at the initial concentration of 5,000 pCi/L. Freshly precipitated calcite solids were allowed to react with Ra²⁺ in solution for 12 h. After that, the calcite solids were separated by filtration and transferred to DI solution containing 0, 0.5, 1.0 and 2.0 M of NaCl for desorption studies that were carried for a period of 12 hours. Ra²⁺ concentration in the liquid phase at the end of adsorption and desorption tests were analyzed by Liquid Scintillation Counter (LSC). The results of these desorption tests are summarized in FIG. 5.

Radium removal efficiency by freshly precipitated CaCO₃ solids during 12 h of contact with the initial Ra²⁺ concentration of 5,000 pCi/L was 80.4%. As can be seen in FIG. 5, when freshly precipitated CaCO₃ solids loaded with Ra²⁺ were placed in the DI solution, the amount of Ra²⁺ released into the solution was very small. Ra²⁺ released into the solutions with ionic strength ranging from 0.5-2.0 M was about 15% and was not affected by the ionic strength. This indicates that the Ra bonded within CaCO₃ is quite stable and hard to desorb. Previous studies of Ra removal with BaSO₄ and Cd²⁺ removal with CaCO₃ reported that the tracer ions tend to exchange with the carrier ion in the solid phase and that this exchange is irreversible. This irreversible conversion also depends on time as the longer contact results in greater irreversible exchange.

Ra removal via CaCO₃ precipitation was also studied in actual produced water from subterranean hydrocarbon recovery. The composition of the produced water obtained from a well in northeastern Pennsylvania denoted as PW N is set forth in Table 4.

TABLE 4

| Species | Concentration |
|---|---|
| Ca²⁺ (mg/L) | 25,534 |
| Ba²⁺ (mg/L) | 7,658 |
| Sr²⁺ (mg/L) | 10,364 |
| Mg²⁺ (mg/L) | 2,176 |
| Ra²⁺ (pCi/L) | 21,550 |
| TDS (mg/L) | 416,200 |
| Ionic Strengths (mol/L) | 2.26 |

The raw, produced water was first filtered through a 0.45-μm membrane to remove suspended solids (SS) and then analyzed for major cations using Atomic Adsorption Spectroscopy (AAS). Total dissolved solids (TDS) concentration was determined by the evaporation methods (90° C. for 12 hours) and Ra concentration was determined using gamma spectrometer with 72 hours of counting time. The filtered wastewater was used in the CaCO₃ co-precipitation experiments in 50 ml HDPE bottle with 20 ml solution. Na₂CO₃ was added to the sample so that the molar concentration of CO₃²⁻ was 10, 20, 30, 50, 70 and 100% of the Ca²⁺ concentration. After mixing for 2 hours, the supernatant was filtered through a 0.45-μm membrane and both solid and liquid samples were saved for further analysis.

The solids created by the addition of Na₂CO₃ to PW N were dissolved in 10 ml of 2M HCl and 5 ml of the solution was used for AAS analysis while the remaining 5 ml was saved for gamma spectroscopy. The AAS results are shown in Table 5.

TABLE 5

| Sample | CO₃²⁻ addition | Ca²⁺ reacted | Sr²⁺ reacted | Ba²⁺ reacted | Mg²⁺ reacted |
|---|---|---|---|---|---|
| No. | (mmol/L) | (mmol/L) | (mmol/L) | (mmol/L) | (mmol/L) |
| 1 | 63.84 | 65.84 | BDL | BDL | BDL |
| 2 | 127.67 | 120.52 | 1.26 | BDL | BDL |
| 3 | 191.51 | 177.91 | 3.79 | 0.87 | BDL |

BDL—Below Detection Limit

As can be seen from Table 5, almost the entire carbonate added to the produced water was used for Ca²⁺ precipitation, which is in agreement with previous observations using the synthetic water.

The supernatant from each test and part of the dissolved solids were analyzed on gamma spectrometer to confirm Ra removal. Each sample was analyzed using the counting time of 24 hours and the results are shown in Table 6.

TABLE 6

| | | Ra in solid phase | Ra in liquid phase |
|---|---|---|---|
| Sample | Exp. Setup | (%) | (%) |
| 1 | 10% CO₃² | 3.14 | 95.38 |
| 2 | 20% CO₃²⁻ | 7.69 | 90.07 |
| 3 | 30% CO₃²⁻ | 22.45 | 79.03 |
| | (1^{st} test) | | |
| 4 | 30% CO₃²⁻ | 12.11 | 86.42 |
| | (2^{nd} test) | | |
| 5 | 50% CO₃²⁻ | 35.64 | 63.75 |
| 6 | 70% CO₃²⁻ | 47.68 | 55.46 |
| 7 | 100% CO₃²⁻ | 75.01 | 26.83 |
| | (1^{st} test) | | |
| 8 | 100% CO₃²⁻ | 83.75 | 20.62 |
| | (2^{nd} test) | | |

Comparison of the results in Table 6 and FIGS. 3A and 3B reveals that Ra removal in real produced water was much lower than Ra removal in synthetic water. It is reasonable to assume that high salinity and competing ions (i.e., Ba²⁺) play an important role in inhibiting Ra removal during co-precipitation or post-precipitation with CaCO_{3.} To confirm this hypothesis, experiments with synthetic solutions were conducted under well-controlled experimental conditions. These experiments used the same initial Ca²⁺ concentration (6,000 mg/L) and equimolar CO₃²⁻, but the ionic strength and Ba²⁺ concentration were adjusted at different levels. The reaction time was 12 hours for both co-precipitation and post-precipitation experiments and LSC was used for Ra analysis. Ra removal at different experimental conditions is shown in Table 7.

TABLE 7

| Experimental | | | | | | |
|---|---|---|---|---|---|---|
| Conditions | Post-precipitation | | | Co-precipitation | | |
| Ca²⁺ concentration | 0.15 | 0.15 | 0.15 | 0.15 | 0.15 | 0.15 |
| (mol/L) | | | | | | |
| Ba²⁺ (mol/L) | 0 | 0.075 | 0 | 0 | 0.075 | 0.075 |
| Na⁺ (mol/L) | 0 | 0 | 0.5 | 0 | 0 | 0.5 |
| Ionic Strength | 0 | 0.225 | 0.5 | 0.3 | 0.525 | 1.025 |
| Ra Removal (%) | 61.05 | 35.09 | 49.9 | 88.94 | 53.85 | 35.74 |

The results presented in Table 7 confirm that that the presence of competing ions (i.e., Ba²⁺, Na⁺) and higher ionic strength inhibit Ra removal by both co-precipitation and post-precipitation with CaCO₃. Furthermore, Ba²⁺ had much greater adverse impact on Ra removal than Na⁺ because it has similar ionic radius with Ra²⁺ and can easily compete with Ra²⁺ and inhibit its uptake by carbonate solids. Inhibition of Ra removal by the increase in ionic strength is most likely due to the decrease of CaCO₃ solubility.

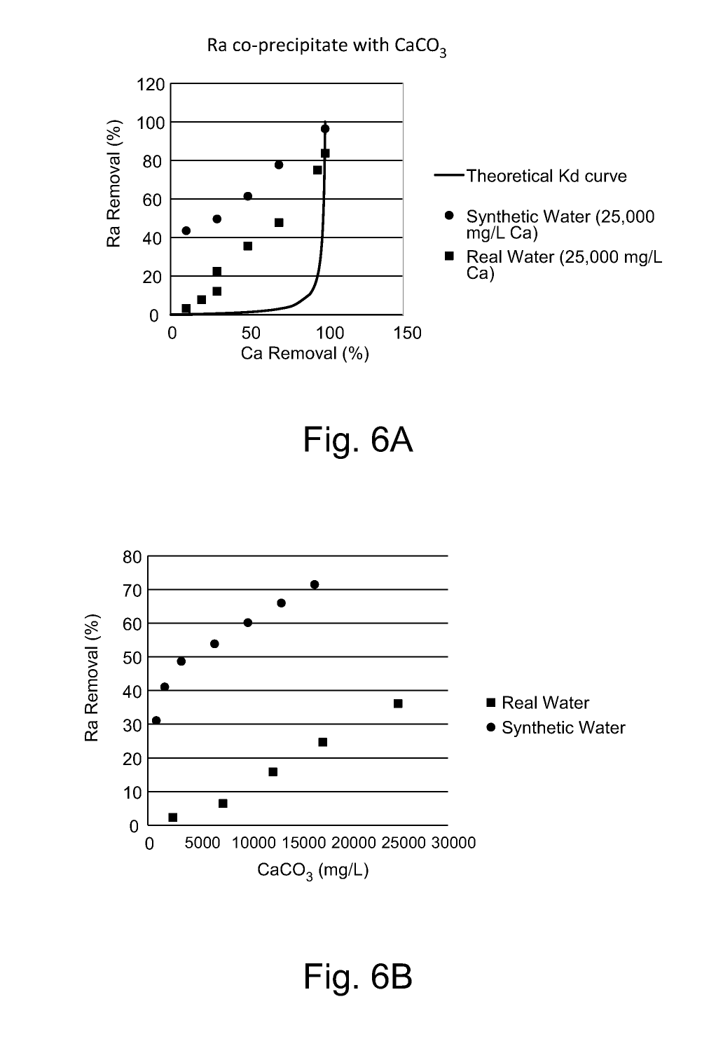

FIG. 6A illustrates a study of removal of Ra via co-precipitation in the produced/flowback water described in Table 4, while FIG. 6B illustrates a study of removal of Ra via post-precipitation in the flowback water described in Table 4. FIGS. 6A and 6B illustrate that Ra removal in real produced water was lower than Ra removal in synthetic water by both co-precipitation and post-precipitation mechanisms. FIG. 6A compares Ra removal by co-precipitation in produced water and in synthetic water that contained only CaCO₃ and Ra²⁺ in deionized (D.I.) water. The results shown in FIG. 6A indicate that Ra removal in real produced water is higher than the theoretical value predicted based on the solid solution theory (higher experimental Ka value means that more Ra is removed during the co-precipitation). Another observation from the results in FIG. 6A is that Ra removal in real produced water is lower than that observed in synthetic water. FIG. 6B indicates that similar behavior was observed in studies that evaluated Ra removal by post-precipitation. It is apparent that the complex chemistry of the real produced water greatly inhibits the overall Ra removal, which may be the result of the competition between Ba²⁺ and Ra²⁺ for lattice replacement and adsorption reactions.

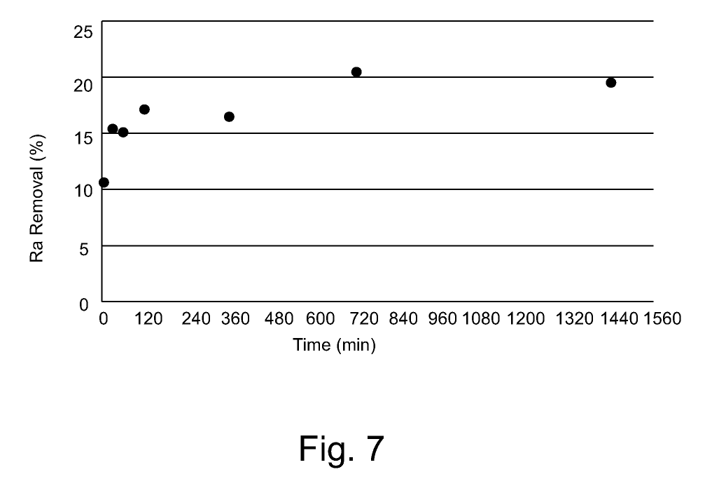

Kinetics of Ra removal in real produced water during post-precipitation was first studied using 500 mL HDPE bottles containing 400 ml of PW N that was first filtered through a 0.45-μm membrane. Freshly precipitated CaCO₃ was added to the solution to achieve solids concentration of 31,250 mg/L CaCO₃, which is equivalent to 50% Ca²⁺ removal from the produced water. 10 ml aliquots taken at different time points were analyzed using gamma spectrometry with 24 hour counting time. The results of these experiments are summarized in FIG. 7.

Experimental results shown in FIG. 7 indicate that Ra removal during post-precipitation is reasonably fast as it approached close to equilibrium within 2 hours of contact with CaCO₃ solids. Ra removal after 3 days was 22% (data not shown), which is very close the removal achieved after 2 hours.

Ra removal in real PW N by post-precipitation with CaCO₃ solids was determined using 50 ml HDPE bottles filled with 20 ml of real produced water. Freshly precipitated CaCO₃ (CaCl₂ and Na₂CO₃ were allowed to equilibrate for 2 hours) was added to each bottle at different concentrations and allowed to react for 2 hours. Supernatant from each reactor was analyzed using gamma spectrometry with 24 hours of counting. Ra removal in these experiments is summarized Table 8.

TABLE 8

| Solids Concentration | Ra Removal |
|---|---|
| (mg/L as Ca²⁺) | (%) |
| 2,500 | 2.34 |
| 7,500 | 6.47 |
| 12,500 | 15.89 |
| 17,500 | 24.64 |
| 25,000 | 36.16 |

The results in Table 8 indicate that Ra removal in real produced water by post-precipitation is limited because of high salinity and competition from divalent cations (i.e., Ba²⁺). However, solids concentration can still affect the removal of Ra by post-precipitation, which implies that both co-precipitation and post-precipitation should be considered to improve the overall Ra removal.

In general, it is desirable to minimize the amount of solids in the form of precipitate formed in the removal of Ra. In that regard, sludge and solids can be difficult to handle or process. Moreover, a number of calcium compounds such as calcium chloride which may be obtained from subterranean hydrocarbon recovery wastewater may be valuable commodities. Thus, it is undesirable to precipitate all of the Ca in the wastewater to remove Ra. In a number of embodiments, sludge recirculation (including precipitated CaCO₃ from a reaction container) to effect post-precipitation Ra removal was evaluated for enhancing Ra removal from wastewater.

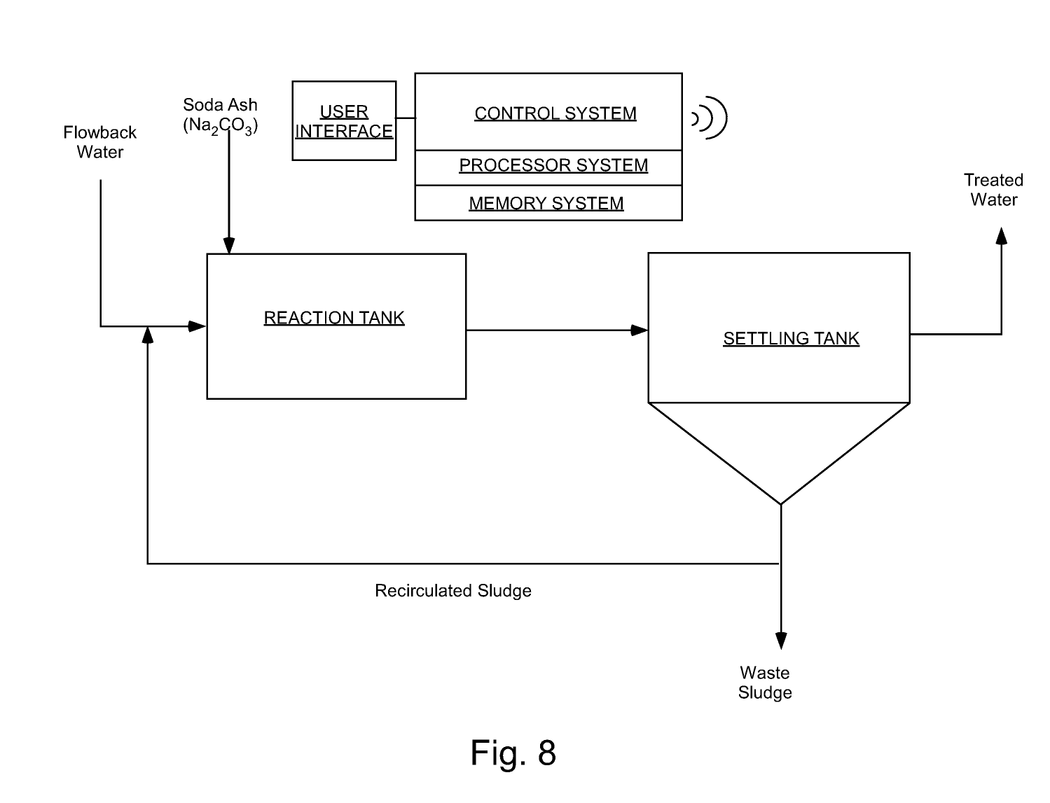

FIG. 8 illustrates schematically an embodiment of a system hereof including sludge recirculation of precipitated CaCO₃ from a settling tank to a reaction tank in which soda ash (Na₂CO₃) is added to flowback water. Because of the pronounced affinity of carbonate to bind with Ca²⁺ over other divalent cations (i.e., Ba²⁺, Sr²⁺ and Mg²⁺), Ca²⁺ will always be the first to precipitate when carbonate is added to produced water. The impact of post-precipitation on Ra removal indicates that it is possible to enhance Ra removal during softening by increasing the sludge recirculating ratio in the treatment system.

As described above the system may include a controller or control system to control various aspects of the system such as the flow of the source of carbonate ions to the reaction tank to cause precipitation of only a portion of calcium in the wastewater and to control the amount of calcium carbonate recycled to the container via the recycle conduit. The control system may, for example, communicate with various input/output systems or components of the system (for example, with sensors, valves, flow controllers etc.) in a wired and/or wireless manner. As known in the control arts, the control system may, for example, include electronic circuitry and/or a processor system including one or more processors (for example, one or more microprocessors) and an associated memory system in communicative connection with processor system. The control system may, for example, be in communicative connection with a user interface system including, for example, one or more displays and input system (for example, one or more of a keyboard, a touchscreen, a mouse, a microphone etc.) as known in the control arts.

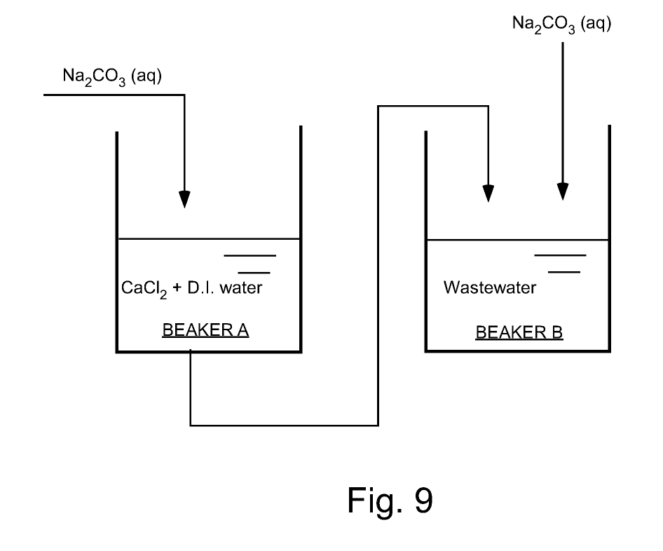

FIG. 9 illustrates a schematic representation of a simulated sludge recirculation process where Ra removal in Beaker B occurred by both co-precipitation and post-precipitation because of the calcite solids added from Beaker A. In studies with the system of FIG. 9, the Ca²⁺ concentration in Beaker A was adjusted between 0-250,000 mg/L to simulate 10, 30, 50, 70 and 100% of the total Ca²⁺ in wastewater and CO₃²⁻ was added at the equimolar concentration as Ca²⁺ and allowed to react for 2 hours. Calcite solids were separated by filtration and transferred to Beaker B. Real produced water in Beaker B (PW N) contained the initial Ca²⁺ concentration of 25,000 mg/L and CO₃²⁻ was added to precipitate 10, 30, 50, 70 or 100% of the total Ca²⁺ in PW N. The solids formed in Beaker B were mixed with the calcite solids transferred from Beaker A and the reaction in Beaker B was allowed to proceed for 2 hours. The supernatant was filtered and analyzed for Ra concentration using gamma spectrometry.

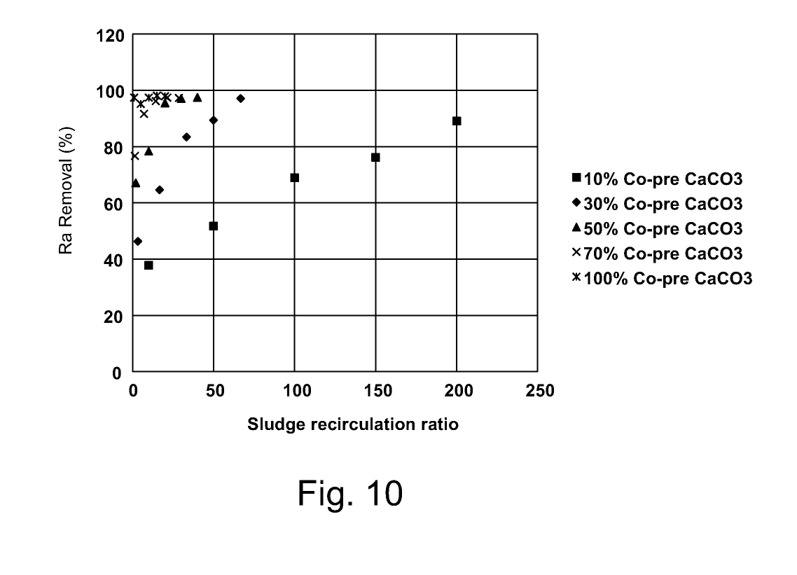

Experimental results in FIG. 10 indicate that Ra removal during softening would increase by recycling precipitated sludge because of the increase in solids concentration in the reactor. It is also noteworthy that the total Ra removal in these experiments designed to simulate sludge recirculation was the sum of Ra removal by co-precipitation and post-precipitation. This finding will allow relatively accurate prediction of Ra removal when using sludge recirculation in the softening reactor.

In a number of embodiments hereof, in the range of 20% to 60% (by weight) of the calcium in the wastewaters is precipitated as, for example, calcium carbonate. The sludge recirculation ratio may, for example, be in the range of 25 to 100 wherein the sludge recirculation ratio is defined as the mass of recirculated calcium carbonate divided by the mass of calcium carbonate created in the container. In a number of embodiments, 25 to 40% of the calcium in the wastewaters is precipitated as calcium carbonate, and the sludge recirculation ratio is in the range of 30 to 80. In a number of embodiments, approximately 30% of the calcium in the wastewaters is precipitated as calcium carbonate. The calcium carbonate produced in the method hereof includes at least 90%, at least 95% or at least 98% of the radium from the wastewater. The percentage of calcium precipitated and the sludge recirculation ratio may be readily adjusted to achieve an optimal or desired result for a particular wastewater formulation.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A method of treating wastewater including calcium ions and radium ions from underground hydraulic fracturing operations, comprising:
charging the wastewater into a container via an inlet in the container;
precipitating a portion of the calcium ions in the wastewater within the container as calcium carbonate;
removing an outflow via an outlet in the container; and
recycling at least a portion of calcium carbonate formed in the container and removed in the outflow back into the container.

2. The method of claim 1 comprising charging a source of carbonate ions into the container to create a mixture of the wastewater and the source of carbonate ions in an aqueous medium within the container and precipitating between approximately 10 to 60% of the calcium by weight in the wastewater in the form of calcium carbonate.

3. The method of claim 1 wherein the portion of the calcium carbonate recycled to the container is recycled from a settling system.

4. The method of claim 2 wherein 20% to 60% by weight of the calcium in the wastewater is precipitated as calcium carbonate.

5. The method of claim 4 wherein a sludge recirculation ratio is in the range of 25 to 100 wherein the sludge recirculation ratio is defined as the mass of recirculated calcium carbonate divided by the mass of calcium carbonate created in the container.

6. The method of claim 5 wherein 25 to 40% by weight of the calcium in the wastewater is precipitated as calcium carbonate and the sludge recirculation ratio is in the range of 30 to 80.

7. The method of claim 6 wherein calcium carbonate produced in the method includes at least 90% of radium from the wastewater.

8. The method of claim 6 wherein calcium carbonate produced in the method include at least 95% of radium from the wastewater.

9. The method of claim 6 wherein the source of carbonate ions is sodium carbonate or potassium carbonate.

10. The method of claim 1 wherein the source of carbonate ions is sodium carbonate or potassium carbonate.

11. The method of claim 8 further comprising depositing the calcium carbonate with radium into a subterranean storage volume.

12. The method of claim 8 further comprising solubilizing the calcium carbonate with radium before depositing the calcium carbonate with radium in the subterranean storage volume.

13. A system for treating wastewater including calcium ions and radium ions, comprising:
a container,
a source of the wastewater in fluid connection with the container;
a source of carbonate ions in fluid connection with the container;
a settling system in fluid connection with an outlet of the container,
a recycle conduit in fluid connection between the settling system and the container to recycle solid calcium carbonate precipitated within the container and settled in the settling system to the container; and
a control system operable to control the flow of the source of carbonate ions to the container to cause precipitation of only a portion of calcium in the wastewater and to control the amount of calcium carbonate recycled to the container via the recycle conduit.

14. The system of claim 13 wherein the control system is configured to control flow from the source of carbonate ions into the container to create a mixture of the wastewater and the source of carbonate ions in an aqueous medium within the container to precipitate between approximately 10 to 60% of the calcium by weight in the wastewater in the form of calcium carbonate.

15. The system of claim 13 wherein the source of carbonate ions is sodium carbonate or potassium carbonate.

16. The system of claim 13 wherein the control system is configured to cause 20% to 60% by weight of the calcium in the wastewater to be precipitated as calcium carbonate.

17. The system of claim 16 wherein the control system is configured to control a sludge recirculation ratio to be in the range of 25 to 100 wherein the sludge recirculation ratio is defined as the mass of recirculated calcium carbonate divided by the mass of calcium carbonate created in the container.

18. The system of claim 16 wherein the control system is configured to cause 25 to 40% of the calcium in the wastewater to be precipitated as calcium carbonate and to cause the sludge recirculation ratio to be in the range of 30 to 80.

19. The system of claim 18 wherein calcium carbonate produced in the system includes at least 90% of radium from the wastewater.

20. The system of claim 18 wherein calcium carbonate produced in the system include at least 95% of radium from the wastewater.

21. The system of claim 18 wherein the source of carbonate ions is sodium carbonate or potassium carbonate.

22. A method of treating wastewater including calcium ions and radium ions, comprising:
charging the wastewater into a container via an inlet in the container; precipitating a portion of the calcium ions in the wastewater within the container and co-precipitating a portion of the radium ions;
removing an outflow via an outlet in the container; and
recycling at least a portion of precipitant formed in the container and removed in the outflow back into the container to adsorb additional radium ions.
